(19) United States
(12) Patent Application Publication
(10) Pub. No.: US 2025/0115722 A1
(43) Pub. Date: Apr. 10, 2025

(54) METHOD AND APPARATUS FOR POLYMER PRECIPITATION

(71) Applicant: SmartDyeLivery GmbH, Jena (DE)

(72) Inventors: Christoph ENZENSPERGER, Jena (DE); Christoph ENGLERT, Jena (DE); Marc LEHMANN, Jena (DE); Stefan REICHERT, Jena (DE)

(21) Appl. No.: 18/836,225

(22) PCT Filed: Feb. 7, 2023
(86) PCT No.: PCT/EP2023/052999

§ 371 Date: Aug. 6, 2024

(30) Foreign Application Priority Data
Feb. 7, 2022 (EP) 22155460.3

(51) Int. Cl. C08J 3/14; B01J 4/00

(52) U.S. Cl. CPC C08J 3/14; B01J 4/002; C08J 2367/04

(57) ABSTRACT

The precipitant is provided in the precipitant reservoir (9), the polymer solution in the reservoir container (6). By means of the precipitant pump (7), the precipitant is fed under pressure to the nozzle arrangement (4) and the free jet (1) is generated. The polymer solution arrives in the form of a continuous, non-atomized polymer solution jet (2) onto the flat side of the free jet (1). At the location (3) of impact of the polymer solution jet (2), the average differential velocity between the precipitant stream and the polymer solution is greater than or equal to one meter per second. Due to corresponding shear forces at the location (3) of impact, a good distribution of the polymer solution on the surface of the free jet (1) and at the same time an immediately good mixing of polymer solution and precipitant is achieved. In the free jet (1), the polymer contained in the supplied polymer solution is precipitated as solid polymer particles. The resulting mixture of precipitant, solvent and polymer solution is collected in a collecting tank (11). In the centrifuge (13) or a filter device, the polymer particles are separated from the liquid.

The present invention relates to a method and apparatus for polymer precipitation.

The basic physical prerequisite for precipitation in general is the mixing of two liquids or liquid mixtures, whereby a substance is dissolved or dispersed in one liquid (or mixture) which is not or to a significantly soluble or dispersible lesser extent in the other liquid (or mixture). In the phase diagram of a three-substance mixture, a corresponding miscibility gap occurs for the range of the three substances in which precipitation is possible. Precipitation can also be caused by a substance being dissolved or dispersed in one of the liquids, which causes a substance dissolved or dispersed in the other liquid to flocculate or agglomerate.

Polymer precipitation is a common method for separating polymers present in a liquid medium. Primarily, polymers contained in a solvent or solvent mixture are to be converted into the solid aggregate state, in particular in particulate form, and/or polymers already present in particulate form are to be separated from a suspension. Polymer precipitation is also used as a purification method, for example to separate previously added reagents (e.g. smaller molecules) or impurities, or to separate polymer fragments or smaller chains.

The precipitated polymer, i.e. converted into solid material of desired consistency, is separated in a further step mechanically, for example by filtering and/or centrifuging, and/or thermally, i.e. by drying.

In case that the temperature, concentration, volumes and the rate of addition have been suitably selected for polymer precipitation, precipitation occurs when the liquid in which the polymer to be precipitated is dissolved is added to the fluid (anti-solvent, referred to in the present application as precipitant), in which the polymer is not soluble or is only soluble to a considerably lesser extent. The previously dissolved polymer precipitates in the form of solid particles. If the solvent of the polymer solution and the precipitant are not or not completely miscible in each other, the interaction at the interfaces may lead to the formation of the solid.

During precipitation of polymers in particular also impurities such as reactants, catalysts or short polymer chains that are more soluble in the precipitant than in the solvent of the polymer solution can be removed.

The purity of the resulting solid can strongly depend on the selected method parameters. Differences in the concentration of the polymer solution can lead to nanoparticles, microparticles or particles in the millimeter range. In polymer purification, undesirable particle size ranges can lead to serious disadvantages: Particles that are too small may still be present in suspension and have to be separated from it by further method steps, such as extraction. In addition, there may be a risk of undesirable side reactions due to the large surface area. Furthermore, in the case of separation by extraction, it is possible that components that have already been separated are re-extracted during extraction by precipitation. On the other hand, particles that are too large may still contain solution inside them and thus be contaminated with their solvent and impurities contained therein.

The skilled person knows that some polymers are difficult or impossible to obtain in desired purity by precipitation, whether because of poor solubility, tendency to swell, or tendency to agglomerate rapidly into low-density solvent-contaminated lumps during precipitation.

Other established methods involve precipitation of polymers in cold solvent, such as ether or hexane at −80° C., but large amounts of water can be condensed in, and the method is difficult to scale up due to high energy consumption.

Spray drying represents another method for obtaining solid, undissolved polymer. This method differs from the others in that it does not involve purification by removal of undesirable materials dissolved in the solvent, but rather relies only on solvent removal, and thus even involves concentration of impurities. The material loss, and in particularly the energy consumption, is generally quite high, and spray drying methodes are only suitable for solvents with a correspondingly low boiling point or high vapor pressure.

On a laboratory scale, precipitation of some polymers works reliably in a beaker with a stirring fish in which a suitable precipitant is placed and the polymer solution is added gradually.

For polymer separation on a larger scale, for example, large-scale reactors are disclosed in WO 2014/207106 A1. Continuous flow methods are also known.

US 2012/245239 A1 as well as EP 0462317 A2 describe high-pressure nozzle chambers, and the publication WO 2008/035028 A1 discloses turbulence chambers with counter-rotating rotors and spray drying.

The patent specification U.S. Pat. No. 3,953,401 describes a method in which atomized polymer solution is applied to a leisurely moving precipitant surface, i.e. either to the stirrer stream of precipitant placed in a stirred vessel, the surface of an open precipitant flume or the precipitant film flowing over a vessel wall.

Large-scale applications can essentially be divided into two categories, each with their own advantages and disadvantages: on the one hand, totally enclosed systems, such as continuous flow, high-pressure nozzle chambers or turbulence chambers, and on the other hand, open large-scale reactors.

In closed systems, there is generally no gas-liquid phase boundary in the reaction chamber, so that floating or flotation is not possible, in contrast to open systems with an existing gas-liquid phase boundary. In closed systems, the addition of the polymer solution always takes place in the precipitation medium, which can limit the permissible concentration range of the polymer solution, depending on the polymer. For example, some polymers have a strong tendency to form large particles or filaments, which have strong adhesive properties and then easily adhere to the reactor edge or stirrer. In order to prevent adhesion or other adverse effects, several precipitants are also used simultaneously, for example in KR 20080051399 A, so that fine particles are produced first and larger particles in a further step. However, this then results in a solvent mixture that cannot be recycled without further processing.

In open systems, the addition can also take place outside the liquid phase. In this case, obstacles such as the floating of the precipitated product (flotation) or the formation of a covering layer on the surface of the precipitant must be overcome. The latter is particularly problematic, since after formation of a covering layer, further precipitation of the polymer is greatly slowed down or even completely prevented.

With respect to this technical background, it is the task of the present invention to provide an alternative technique for separating a polymer from a polymer solution, which at least partially avoids or reduces known disadvantages of conventional methods.

According to one aspect of the invention, this task is solved with a method according to claim 1. According to a further aspect of the invention, this task is solved with an apparatus according to claim 12. Advantageous embodiments of the invention can be implemented according to one of the dependent claims.

The present invention thus provides in particular a method for polymer precipitation in which a polymer solution is added to a precipitant stream, wherein the precipitant stream being presented as a free jet at the point where the polymer solution is added to the precipitant stream, preferably as a free jet emerging into a gaseous medium, in particular air. According to the usual definition, in the context of the present invention, a free jet is understood to be the flow of a fluid from an opening into the free environment, i.e., in particular without a wall boundary of the jet transverse to its flow direction (main direction of propagation).

According to the invention, the polymer is precipitated into a jet of precipitant. Due to the differential velocity between precipitant and polymer solution, the jet distributes the added polymer solution at the position where it is added. This effect is enhanced by the flow of surrounding fluid, in particular air flow, which the free jet generates in its environment due to fluid mechanical effects. Small drops of the solution are located directly in the precipitant and rapidly exchange solvent as well as soluble impurities by diffusion, since the diffusion paths between polymer solution and precipitant are short. Solvent is completely removed from the polymer.

In conventional precipitation methods, on the other hand, the droplet size depends on concentration and solvent and is therefore difficult to change.

Thus, a simple and cost-effective method has been created which allows good mixing of precipitant and polymer solution, is easily scalable, and can be adapted to a wide range of boundary conditions by means of easily adjustable parameters, such as volume flows of precipitant and polymer solution and the speed of the free jet. According to the invention, a very pure product is achieved in that the diffusion paths between polymer solution and precipitant are short, as explained above.

The method according to the invention can be used not only for the purification of polymers after polymerization or modification of the solid product properties. Due to the high velocity differences between the polymer solution and the precipitant, swelling polymers that are usually not recoverable by precipitation can also be converted into a solid form.

Furthermore, the method according to the invention offers a new way for the continuous production of submicron particles up to nanoparticles.

Another possible use of the method according to the invention is the separation of polymer blends due to the shear forces generated, especially when polymers with fillers or polymer blends are to be separated from each other.

Another area of application of the method according to the invention is the expansion of polystyrene. Due to the high air input in the vicinity of the free jet, it is possible that the polymer particles produced may have particularly large surfaces and/or may also have cavities inside.

Even polymers whose solvent is not soluble in the precipitant can be precipitated by the method according to the invention in a way that is surprising to the person skilled in the art. As far as the precipitant is concerned, the skilled person is surprisingly not even restricted to the use of liquids, but the method according to the invention can also be advantageously implemented with gaseous precipitants such as water vapor or carbon dioxide, i.e. the aggregate state of the precipitant stream in the free jet can be gaseous, or the precipitant jet can be presented as an aerosol jet. However, in a large number of the precipitation tasks for which the method according to the invention can be advantageously used, the aggregate state of the precipitant stream in the free jet will be liquid.

Preferably, the polymer solution is added to the precipitant stream in non-atomized form, i.e. not sprayed onto the free jet but poured on, dripped on or sprayed on in the form of one or more liquid jets. The equipment required is thus less than if atomization had to be provided. Technical problems such as clogging or uneven spraying of atomizing nozzles are thus avoided in advance. The shear forces acting on the surface of the free jet ensure sufficient distribution of the polymer solution, so that atomization of the polymer solution is unnecessary in most cases.

Particularly preferably, the free jet is generated as a flat jet, advantageously e.g. by means of a flat jet nozzle or flat nozzle or an arrangement of two or more nozzles lined up in the lateral direction. In this context, a flat jet is considered to be a jet whose extent in the region of the addition of the polymer solution in a first spatial direction orthogonal to the main direction of propagation of the free jet is at least twice, preferably at least four times, as wide as in a second spatial direction which is orthogonal both to the first and to the main direction of propagation of the free jet. The surface area of the free jet onto which polymer solution can impinge is thus increased compared to an omnidirectional jet for the same precipitant stream. The main direction of propagation of the free jet is defined as the spatial direction orthogonal to the surface through which the volume flow of the precipitant is highest.

According to a particularly advantageous embodiment, the average differential velocity Av between the precipitant stream and the polymer solution upon impact with the precipitant stream is greater than or equal to one meter per second, preferably greater than or equal to three meters per second. In this case, the mean differential velocity Δv at impact is calculated as the difference between a first quotient formed from the volumetric flow Q_{F} of the precipitant stream in the main direction of propagation of the precipitant stream (in the numerator) and the area A_{F} traversed by the precipitant stream perpendicular to the main direction of propagation of the precipitant stream at the median impact location (in the denominator), and a second quotient formed from the volumetric flow Q_{P} of the polymer solution not yet impinged on the precipitant stream in the main direction of propagation of the precipitant stream (in the numerator) and the area A_{P} through which the polymer solution flows perpendicular to the main direction of propagation of the precipitant stream at the median impact location (in the denominator). Thus, Δv=Q_{F}/A_{F}−Q_{P}/A_{P}.

The median impact location is defined as a plane orthogonal to the main direction of propagation of the precipitant stream, upstream and downstream of which half of the supplied polymer solution stream meets the precipitant stream. “Upstream” and “downstream” refer to the precipitant stream upstream and downstream, respectively.

As a simplified design criterion in an advantageous embodiment, the difference between the average velocity of the precipitant stream as it exits a nozzle and the average velocity of the polymer solution as it exits a polymer solution exit orifice may be selected to be greater than or equal to one meter per second, preferably greater than or equal to three meters per second, wherein the mean velocity of the precipitant stream as it exists the nozzle is the quotient of the volumetric flow of the precipitant stream as it exists the nozzle and the area of the nozzle orifice A_{D} traversed, and the mean velocity of the polymer solution as it exists the polymer solution outlet orifice is the quotient of the volumetric flow of the polymer solution as it exists the polymer solution outlet orifice and the area of the polymer solution outlet orifice traversed.

According to an advantageous embodiment, the Reynolds number Re at the exit of the precipitant stream from a nozzle for the formation of the free jet is at least 2300, wherein the Reynolds number Re is formed as the product of the quotient of the volumetric flow Q_{F} of the precipitant stream exiting the nozzle (in the numerator) and the area of the nozzle opening through which the flow passes A_{D} (in the denominator) and the quotient of the smallest diameter do of the nozzle at its exit (in the numerator) and the dynamic viscosity ν_{F} of the precipitant (in the denominator) according to Re=Q_{F}/A_{D}−d_{D}/ν_{F}. In this way, turbulent jet formation can be achieved, which is particularly supportung the mixing of precipitant and polymer solution.

According to a further advantageous embodiment, the place of addition of the polymer solution is in a gas-filled space at a gas pressure below 0.2 MPa. This allows the method to be carried out at ambient pressure without any technical effort.

According to an advantageous embodiment, precipitant and solvent in the polymer solution are selected such that the ratio of the maximum solubility of the polymer in the precipitant of the precipitant stream to the concentration of the polymer in a solvent contained in the polymer solution is smaller by at least a factor of 10, preferably at least a factor of 25, particularly preferably at least a factor of 100, than the ratio between the volumetric flow of the solvent when the polymer solution is added and the volumetric flow of the precipitant stream.

According to a particularly preferred embodiment, the main direction of propagation of the free jet at its exit from a nozzle is inclined downward at an angle to the horizontal of at least 20 and at most 70 degrees, preferably at least 35 and at most 55 degrees.

The present invention also provides a polymer precipitation apparatus comprising a precipitant feed for feeding precipitant, a nozzle arrangement for producing a free jet from fed precipitant, and an addition apparatus for adding polymer solution on the free jet.

According to an advantageous embodiment, the nozzle arrangement has a flat jet nozzle or flat nozzle. A flat nozzle is understood to mean in particular a nozzle whose outlet opening transversely to the outlet opening is at least twice as wide as it is high, preferably at least four times as wide as it is high. In other words, the largest lateral extent of a surface spanned by the border of the outlet opening of the nozzle is in particular at least twice as large, preferably at least four times as large, as the lateral extent of this surface orthogonal to its largest lateral extent. Also understood as a flat nozzle is a nozzle which has at its outlet an open notch or groove laterally to the main outlet direction towards two opposite sides, e.g. in the form of a milled-out area, the notch or groove being in its projection in the main outlet direction at least twice as wide as high, preferably at least four times as wide as high. In other words, the largest lateral extent of the notch or groove in its projection in the main outlet direction is in particular at least twice as large, preferably at least four times as large, as the lateral extent of the projection orthogonal to its largest lateral extent.

According to a particularly preferred embodiment, the nozzle arrangement defines an exit direction for the free jet that is downwardly inclined at an angle of at least 20 and at most 70 degrees, preferably at least 35 and at most 55 degrees.

Preferably, the apparatus further comprises a collecting device for collecting the mixture formed by adding the polymer solution and a separation apparatus, for example centrifuge and/or filter device for separating precipitated polymer from the collected mixture.

The invention is explained in more detail below in an exemplary manner with reference to the attached schematic drawings. The drawings are not to scale; in particular, for reasons of clarity, the relationships of the individual dimensions to one another do not correspond in part to the dimensional relationships in actual technical implementations. Preferred embodiments are described, but the invention is not limited to these.

In principle, any variant of the invention described or indicated within the scope of the present application may be particularly advantageous, depending on the economic, and technical conditions in the individual case. As far as nothing to the contrary is stated, or as far as technically feasible in principle, individual features of the described embodiments are interchangeable or combinable with each other as well as with features known per se from the prior art.

It shows

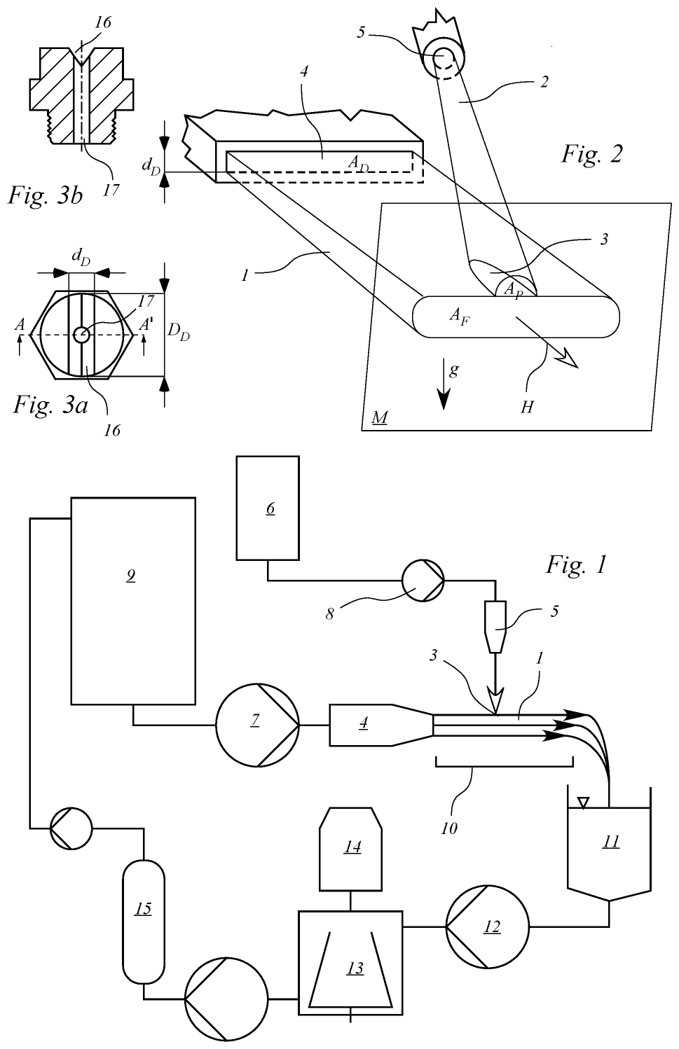

FIG. 1 a method flow diagram relating to an embodiment of the present invention,

FIG. 2 in schematic perspective view, the geometric conditions at the point of addition of polymer solution to the precipitant jet according to an embodiment example of the present invention,

FIG. 3a shows an example of a flat nozzle in plan view

FIG. 3b shows an example of a flat nozzle in a cross-sectional view in the sectional plane indicated by the broken line A-A′ in FIG. 3A.

Corresponding elements are identified in the drawing figures with the same reference signs.

FIG. 1 shows a method flow diagram for an embodiment example of the present invention. The precipitant, for example water, is provided in the precipitant reservoir 9, and the polymer solution, for example PLGA in acetone, is provided in the reservoir container 6. By means of the precipitant pump 7, which may be a pump type customary per se in the prior art, for example a centrifugal pump, the precipitant is fed under pressure from the precipitant reservoir 9 to the nozzle arrangement 4 and the free jet 1 is generated. The medium surrounding the free jet, in which the precipitant is in a liquid state, is air.

The free jet is a flat jet whose extension, as illustrated in FIG. 2, transverse to the main direction of propagation of the free jet 1 and to the force of gravity g is greater by a factor of 2 than its extension in the direction of force of gravity g. In the region of the free jet 1 is the location 3 of the addition of the polymer solution, which impinges on the flat side of the free jet 1 in the form of a continuous, non-atomized polymer solution jet 2. As addition apparatus 5 can advantageously be provided a nozzle from which the polymer solution jet 2 exists under pressure, or simply a pipe opening from which the polymer solution jet 2 runs out following the force of gravity g.

The polymer solution is fed to the addition apparatus 5 by the feed pump 8. Again, a pump type known per se from the prior art, for example a peristaltic pump, can be used as the feed pump 8.

At the location 3 of impact of the polymer solution jet 2 on the free jet 1, more precisely: at the median impact location M, the average differential velocity Δv between the precipitant stream and the polymer solution is greater than or equal to one meter per second:

$$Δ v = {Q}_{F} / {A}_{F} - {Q}_{P} / {A}_{P} \geq 1 m \cdot {s}^{- 1}$$

In it is
Q_{F} the volume flow of the precipitant stream in the main direction of propagation H,
A_{F} the area traversed by the precipitant stream perpendicular to the main direction of propagation H of the free jet 1 at the median impact location M,
Q_{P} is the volume flow of the polymer solution not yet impinged on the free jet 1 in the main direction of propagation H of the free jet,
A_{P} the area A_{P} traversed by the polymer solution jet 2 perpendicular to the main direction of propagation H of the free jet 1 at the median impact location M

The median impact location M is defined as a plane orthogonal to the main direction of propagation H of the free jet 1, in front of and behind which half of the polymer solution supplied per unit of time impinges on the free jet 1, wherein the main direction of propagation H of the free jet 1 being understood to be the spatial direction orthogonal to the surface through which the volume flow of the precipitant is highest.

Due to the high differential velocity and corresponding shear forces at the location of impact 3, the impinging polymer solution jet 2 is sort of torn apart and a good distribution of the polymer solution on the surface of the free jet 1 and at the same time a good mixing of the polymer solution with the precipitant, which starts immediately, is achieved. The mixing can be further improved by a jet flow that is as turbulent as possible. This can be achieved in particular if the Reynolds number at the outlet of the flat nozzle 4 is at least 2300:

$$Re = {Q}_{F} / {A}_{D} \cdot {d}_{D} / {v}_{F} \geq 2300$$

In it is
Q_{F} the volume flow of precipitant exiting the flat nozzle 4,
A_{D} the flowed through area of the nozzle opening,
d_{D} the smallest inside diameter of the flat nozzle 4 at its outlet and
ν_{F} the dynamic viscosity ν_{F} of the precipitant.

The protective pan 10 is used to collect any precipitant, polymer or solvent lost by splashing or dripping in the area of the polymer solution addition.

In free jet 1, the polymer contained in the supplied polymer solution is precipitated by the mixing of precipitant and solvent in the form of solid polymer particles. The resulting mixture of precipitant, solvent and precipitated polymer is collected in the collecting tank 11. The suspension pump 12, which may again be a pump per se of a type known in the prior art, conveys the mixture to the centrifuge 13 or a filter device for solid-liquid separation. Here, the polymer particles are separated from the liquid. In the dryer 14, liquid residues can still be thermally removed from the polymer particles, if necessary.

Precipitant cleaned of solvent in the separation apparatus 15 can be recycled, i.e. recirculated and used again in the precipitant reservoir 9.

While FIG. 1 schematically shows a flat nozzle or slit nozzle with an essentially rectangular outlet, the outlet opening can also be rounded on the narrow sides, for example, by being produced by squeezing an originally cylindrical or oval tube. FIGS. 3a and 3b show a flat jet nozzle with a notch 16 orthogonal to the cylindrical nozzle bore 17. In its projection perpendicular to the main outlet direction, the maximum lateral extent of the groove D_{D} is 3.2 times as large as the lateral extent d_{D} orthogonal thereto.

### Example 1

For nanoparticle production, 50 mg of polylactide-co-glycolide (PLGA) is dissolved in 2 ml of dimethyl sulfoxide (DMSO) and precipitated in water. The precipitant water is thereby introduced as a free jet, which exits a flat jet nozzle into ambient air at a flow rate of about 400 ml/min at an angle of about 45° (downward inclined) to the horizontal. The PLGA solution is applied to the precipitant stream in the direction of gravity from a vertically mounted cannula with syringe pump at a flow rate of approximately 99 ml/hr. Some precipitant (approx. 0.5 l) is added to the precipitant stream collecting tank so that it is not dry.

Particles with a harmonic intensity-averaged particle diameter (Z-average) of 89.5 nm and a polydispersity index of 0.15, as determined by dynamic light scattering, are produced. The zeta potential is −27 mV.

After the PLGA solution provided is used up, the nanoparticles contained in the collected precipitant are concentrated and purified by adding 5 ml of 3% polyvinyl alcohol solution by tangential flow filtration.

1.-15. (canceled)

16. A method for precipitating a polymer, comprising adding a polymer solution (2) to a precipitant stream (1), wherein
the precipitant stream (1), at a location (3) of adding the polymer solution (2) to the precipitant stream (1), is presented in form of a free jet emerging into a gaseous medium;
the aggregate state of the precipitant stream in the free jet is liquid; and
a difference between an average velocity of the precipitant stream (1) as it exits a nozzle (4) and an average velocity of the polymer solution (2) as it exits a polymer solution exit orifice is greater than or equal to one meter per second, wherein
the average velocity of the precipitant stream (1) as it exits the nozzle (4) being a quotient of a volume flow Q_{F} of the precipitant stream (1) emerging from the nozzle (4) and an area of a nozzle orifice A_{D} through which the precipitant stream passes, and
the average velocity of the polymer solution (2) as it exits the polymer solution outlet opening is a quotient of a volume flow of the polymer solution (2) as it exits the polymer solution outlet opening and an area of the polymer solution outlet opening through which the polymer solution (2) flows.

17. The method according to claim 16, wherein the polymer solution (2) is presented unatomized at the location (3) of its adding to the precipitant stream (1).

18. The method of claim 16, wherein the free jet is generated as a flat jet.

19. The method of claim 16, wherein an average differential velocity Δv between the precipitant stream (1) and the polymer solution (2) when impinging on the precipitant stream (1) is greater than or equal to one meter per second, wherein
the mean differential velocity Δv is calculated according to Δv=(Q_{F}/A_{F})—(Q_{P}/A_{P}), with Q_{F}/A_{F} being the quotient formed from the volume flow Q_{F} of the precipitant stream (1) in a main direction of propagation (H) of the precipitant stream (1) and the area A_{F} through which the precipitant stream (1) flows perpendicular to the main direction of propagation (H) of the precipitant stream (1) at a median impact location (M), and Q_{P}/A_{P} being the quotient formed from the volume flow Q_{P} of the polymer solution (2) which has not yet impinged on the precipitant stream (1) in the main direction of propagation (H) of the precipitant stream and the area A_{P} through which the polymer solution flows perpendicular to the main direction of propagation (H) of the precipitant stream (1) at the median impact location (M),
wherein the median impact location (M) being defined as a plane orthogonal to the main direction of propagation (H) of the precipitant stream (1), upstream and downstream of which plane half of the polymer solution (2) supplied per unit time impinges on the precipitant stream (1), and
wherein the main direction of propagation (H) of the precipitant stream denotes the direction of space orthogonal to the surface through which the volume flow of the precipitant is highest.

20. The method according to claim 16, wherein a Reynolds number Re of the precipitant stream (1) at the exit from the nozzle (4) when forming the free jet is at least 2300,
the Reynolds number Re being a product according to Re=(Q_{F}/A_{D})·(d_{D}/v_{F}),
with Q_{F}/A_{D} being a quotient of the volume flow Q_{F} of the precipitant stream (1) exiting the nozzle (4) and the area of the nozzle opening A_{D} through which the precipitant stream passes, and
with d_{D}/ν_{F} being a quotient of a smallest diameter d_{D} of the nozzle (4) at its outlet and a dynamic viscosity ν_{F} of the precipitant.

21. The method according to claim 16, wherein the site (3) of adding the polymer solution to the precipitant stream (2) is in a gas-filled space at a gas pressure below 0.2 MPa.

22. The method according to claim 16, wherein a ratio of a maximum solubility of the polymer in a precipitant of the precipitant stream to a concentration of the polymer in a solvent contained in the polymer solution (2) is smaller by at least a factor of 10 than a ratio between a volumetric flow of the solvent when the polymer solution (2) is added and a volumetric flow (1) of the precipitant stream.

23. The method according to claim 16, wherein the main direction of propagation of the precipitant stream (1) at the exit of the nozzle (4) is inclined downwardly at an angle to the horizontal of at least 20 degrees and not greater than 70 degrees.

24. An apparatus for precipitating a polymer, the apparatus comprising:
a precipitant feeder for feeding a liquid precipitant;
a nozzle arrangement for generating, in a gaseous medium, a precipitant stream in form of a free jet from the supplied liquid precipitant; and
an addition apparatus (5) for adding a polymer solution to the precipitant stream,
wherein the nozzle arrangement and the addition apparatus are configured that
a difference between an average velocity of the precipitant stream as it exits a nozzle (4) of the nozzle arrangement for generating the free jet and an average velocity of the polymer solution (2) as it exits a polymer solution exit orifice of the addition apparatus is greater than or equal to one meter per second, wherein
the average velocity of the precipitant stream (1) as it exits the nozzle (4) being a quotient of a volume flow Q_{F} of the precipitant stream emerging from the nozzle (4) and an area of the nozzle orifice A_{D} through which the precipitant stream (1) passes, and
the average velocity of the polymer solution (2) as it exits the polymer solution outlet opening is a quotient of a volume flow of the polymer solution (2) as it exits the polymer solution outlet opening and the area of the polymer solution outlet opening through which the polymer solution (2) flows.

25. The apparatus according to claim 24, wherein the nozzle assembly comprises a flat jet nozzle (4).

26. The apparatus according to claim 24, further comprising:
a collecting device for collecting a mixture formed by adding the polymer solution to the precipitant stream, and
a separation apparatus for separating a precipitated polymer from the collected mixture.

27. The apparatus according to claim 24, wherein the nozzle arrangement defines an exit direction for the precipitant stream which is downwardly inclined at an angle to the horizontal of at least 20 and at most 70 degrees.
